(19) United States
(12) Patent Application Publication
(10) Pub. No.: US 2014/0254302 A1
(43) Pub. Date: Sep. 11, 2014

(54) STRUCTURE OF PRESS-TO-OPERATE STIRRING CONTAINER

(71) Applicant: Shiu-Cheng YANG, Taoyuan County (TW)

(72) Inventor: Shiu-Cheng YANG, Taoyuan County (TW)

(21) Appl. No.: 14/016,244

(22) Filed: Sep. 3, 2013

(30) Foreign Application Priority Data
Mar. 5, 2013 (TW) 102107735

(51) Int. Cl. B01F 9/10

(52) U.S. Cl. CPC B01F 9/106
USPC 366/129; 366/220; 366/225; 366/227

(57) ABSTRACT

A press-to-operate stirring container includes a container, a fixing base, a rotating device, an actuation member, and an elastic body. The rotating device is mounted in the fixing base and includes a rotor having a unidirectional rotation driving member coupled to the container so that the container is driven by the rotor to rotate unidirectionally. The actuation member is arranged vertical in the fixing base and is depressible for driving the rotating device. The elastic body helps position returning of the actuation member. As such, a user is allowed to easily control the container to rotate through a pressing-down operation so as to apply effects of stirring and reducing temperature of the substance (such as liquid) received and held in the container. Further, the actuation member can readily keep the container continuously rotating thereby achieving convenient and effective control of stirring speed of the container.

### (a) TECHNICAL FIELD OF THE INVENTION

The present invention generally relates to a structure of a stirring container, and more particularly to a structure of a press-to-operate stirring container that enables a user to control the container to rotate through a press-down operation so as to achieve effects of stirring and reducing temperature of a substance (such as liquid) received in the container and allows easy control of the stirring speed of the container.

### (b) DESCRIPTION OF THE PRIOR ART

Modern people are used to making or brewing a beverage, such as coffee, milk, and tea. The general process is first depositing coffee powder or milk powder into a container and the pouring hot water into the container, followed by a step of stirring. To make the brewed beverage, such as coffee powder and milk powder, completely dissolved in water, stirring must be carried out for a substantial period of time before complete dissolution in water can be achieved. Further, after the beverage has been made, it is still hot for drinking, so that further stirring is necessary for lowering the temperature of the brewed beverage in order to make it fit to drinking.

Generally speaking, stirring is made by hand holding a stirring bar, which can be for example a chopstick, a rod bar, or even a spoon, and circling the stirring bar in the water. This requires a stirring bar to be prepared in advance and may also lead to a potential risk of burning a nearby person if the application of force for stirring is inadequate to cause spoiling of the hot brewed beverage. In addition, the user may sometimes feel tired and sore in the hand holding the stirring bar. Apparently, this way of stirring is generally inconvenient.

Techniques and structures associated with stirring of beverage are known from for example Taiwan Utility Model No. M405243, which teaches using a press-down device to drive a stirring bar to rotate in a containing chamber in order to achieve an effect of stirring and mixing a powder-like substance and a liquid contained in the chamber. However, such a known device has at least the following advantages:

(1) A stirring bar arranged at a bottom of a cup is used to stir the substance received in the cup. The stirring is simply an operation carried out at the bottom of cup by the stirring bar and the cup itself is fixed and not rotating. The result of stirring is thus very limited. A preferred way includes simultaneous rotation of the cup in order to enhance the effect of stirring.

(2) The rotation of the stirring bar is driven by a press-down device, a rotating device, and a rack-gear based transmission structure. No one-way driving structure, such as one-way bearing, is arranged between the rotating device and the stirring bar. Thus, after the press-down device has been pressed down to cause the stirring bar to rotate, during the process when the press-down device is moved by a spring force in an opposite direction to return to the original condition, since the rotating device and the stirring bar are still in a mated condition, if the user attempts to take a further pressing action to make the stirring bar further rotating, then the direction of driving so made is exactly opposite to the direction in which the stirring bar is rotating. Consequently, a resisting force is induced and jamming may occur, making it difficult to smoothly press down the press-down device thereby the speed of the stirring bar being not controllable.

(3) As discussed in the above point (2), during the process when the press-down device returns to the original condition, the stirring bar is also caused to rotate in the opposite direction, so that the stirring bar cannot keep on rotating in the same direction.

Thus, the known technique and structure for stirring beverage are not perfect and further improvement is desired.

The present invention aims to provide a solution that realizes such an improvement.

### SUMMARY OF THE INVENTION

An object of the present invention is to provide a structure of a press-to-operate stirring container that allows control of the container to rotate through a press-down operation so as to achieve effects of stirring and reducing temperature of a substance received in the container and also allows easy control of the stirring speed of the container.

To achieve the above object, the present invention comprises a container, a fixing base, a rotating device, an actuation member, and an elastic body, wherein the container receives and holds therein a substance to be stirred; the fixing base carries and supports the container; the rotating device comprises a rotor rotatably mounted in the fixing base, wherein the rotor comprises a unidirectional rotation driving member and a pinion, the unidirectional rotation driving member being coupled to a bottom of the container to allow the rotor to drive the container to rotate unidirectionally; the actuation member is arranged vertical in the fixing base and has an upper end that is adapted to be pressed down for vertical reciprocal movement, the actuation member comprising an operation section, which drives the pinion to rotate; and the elastic body is arranged in the fixing base for position returning of the actuation member in the reciprocal movement. As such, a user is allowed to easily control the container to rotate through a pressing-down operation so as to apply effects of stirring and reducing temperature of the substance (such as liquid) received and held in the container. Further, the actuation member can readily keep the container continuously rotating thereby achieving convenient and effective control of stirring speed of the container.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is a cross-sectional view of the present invention.

FIG. 4 is a top view, in sectioned form, showing a fixing base according to the present invention.

FIG. 5 is a cross-sectional view illustrating an operation of the present invention.

FIG. 6 is a top view, in sectioned form, showing the fixing base of the present invention in the operation thereof.

FIG. 7 is a top view, in sectioned form, showing a structure that provides an illumination effect and functions as a power supply according to the present invention and an operation thereof.

FIG. 8 is a perspective view of the present invention that provides the illumination effect and functions as a power supply.

FIG. 9 is an exploded view showing another preferred embodiment of the present invention.

FIG. 10 is a cross-sectional view showing said another preferred embodiment according to the present invention.

FIG. 11 is a top view, in sectioned form, showing a fixing base according to said another embodiment of the present invention.

FIG. 12 is a cross-sectional view illustrating an operation of said another preferred embodiment of the present invention.

FIG. 13 is a top view, in sectioned form, showing the fixing base of said another embodiment of the present invention in the operation thereof.

FIG. 14 is a top view, in sectioned form, showing a structure that provides an illumination effect and functions as a power supply according to the present invention and an operation thereof.

FIG. 15 is a perspective view illustrating said another embodiment that provides the illumination effect and functions as a power supply.

FIG. 16 is a perspective view showing a container according to the present invention comprising a curved rib like blending member comprising curved ribs.

FIG. 17 is a perspective view showing a container according to the present invention comprising a projecting blade like blending member and a curved rib like blending member.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

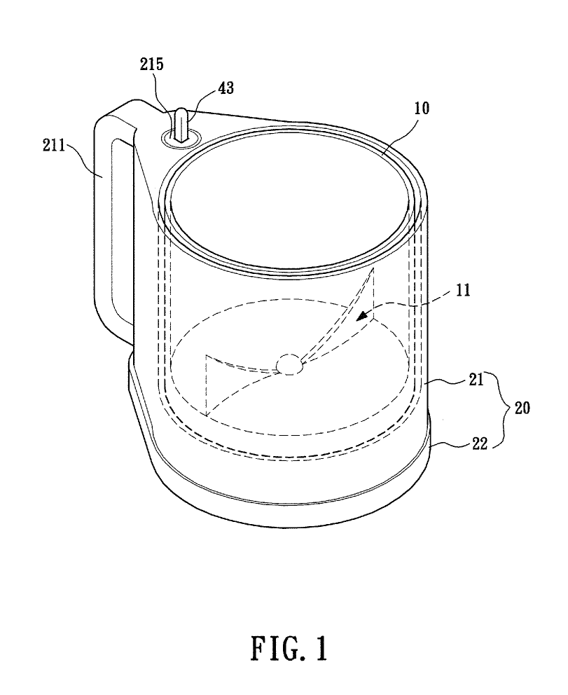

Referring to FIGS. 1, 2, and 5, a preferred embodiment of the present invention comprises a container 10, a fixing base 20, a rotating device 30, an actuation member 40, and an elastic body 50. The actuation member 40 is depressible down to drive the container 10 to rotate, thereby achieving an effect of stirring and reducing temperature of a substance (such as liquid) received in the container 10 and allowing a user to readily and successively depress down the actuation member 40 to cause the container 10 to continuously carry out a stirring operation so as to conveniently and effectively control the stirring speed of the container 10.

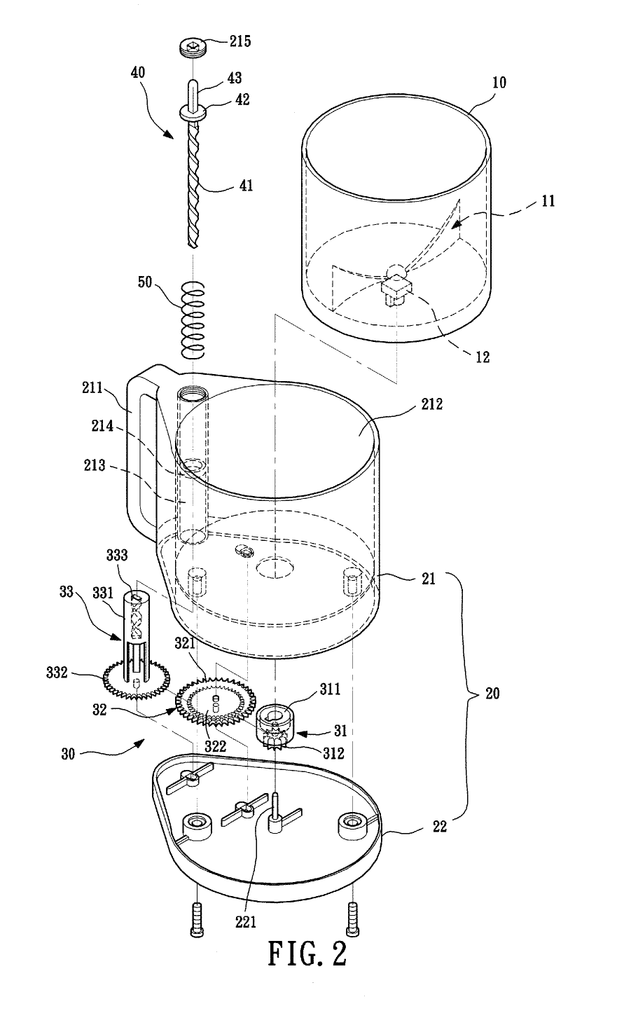

Referring to FIGS. 1 and 2, the container 10 according to the present invention is provided for receiving and con awning a substance, such as one of liquid, powder and solid or a combination thereof. The container 10 has an inside bottom on which at least one blending member 11, which is arranged in the form of projecting blades and has a shape complying with fluid stirring engineering, is provided for stirring the substance. The container 10 has an outside bottom in which an axle 12 is formed.

Referring to FIGS. 1 and 2, the fixing base 20 according to the present invention is provided in the form of a cup. The fixing base 20 comprises a casing 21 and a bottom board 22 so as to define a receiving space in an interior of a lower portion of the fixing base 20. The casing 21 is provided with a hand-holding section 211 which can be held by a hand. The casing 21 forms a chamber 212 having a diameter greater than the container 10 for receiving and holding the container 10 therein. The casing 21 comprises a vertical compartment 213 formed in one side thereof (preferably being located adjacent to the hand-hold section 211) for receiving therein the actuation member 40. A partition 214 is provided in the vertical compartment 213 to divide the vertical compartment 213 into an upper portion and a lower portion.

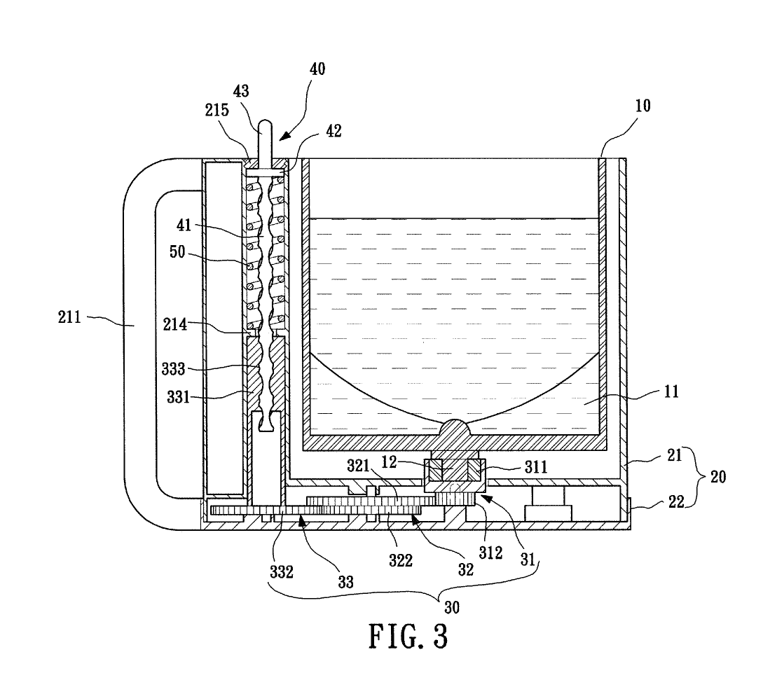

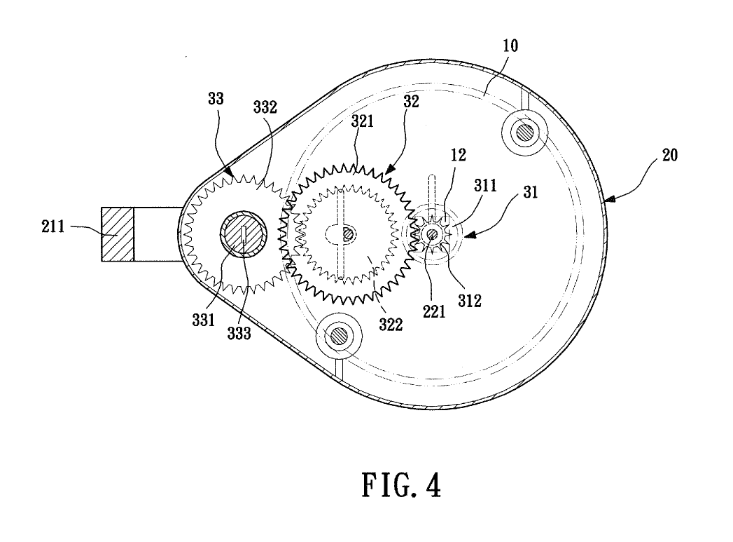

Referring to FIGS. 2, 3, and 4, the rotating device 30 according to the present invention comprise a rotor 31 that is rotatably arranged in the receiving space of the fixing base 20, a toothed wheel unit 32, and a transmission member 33. The rotor 31 is rotatably mounted to a positioning bar 221 mounted on the bottom board 22. The rotor 31 comprises a unidirectional rotation driving member 311, such as a one-way bearing, set at an upper portion thereof. The rotor 31 comprises a pinion 312 arranged at a lower portion thereof. The rotor 31 is set through a bottom of the chamber 212 to allow the unidirectional rotation driving member 311 is coupled to the axle 12 of the container 10 so that the rotor 31 may drive the container 10 to rotate unidirectionally.

The toothed wheel unit 32 comprises a toothed disk 321 at an upper side thereof and a transmission gear 322 at a lower side thereof. The toothed disk 321 is engageable with and drives the pinion 312.

The transmission member 33 comprises a vertical holed shaft 331 and a coupling gear 332 at a lower end of the holed shaft 331. The holed shaft 331 comprises a helical through hole 333 extending axially therethrough. The holed shaft 331 is received in the lower portion of the vertical compartment 213 in such a way that a top of the holed shaft 331 abuts the partition 214, whereby the transmission member 33 is set at a predetermined location and is rotatable. The coupling gear 332 is in engagement with and drives the transmission gear 322.

The actuation member 40 comprises an operation section 41. The operation section 41 is of a helical form to be screwed into the through hole 333 of the holed shaft 331. The actuator 40 has an upper end on which a stop rim 42 and a pressing section 43 are formed and is arranged to have the operation section 41 partly extend through the partition 214 of the vertical compartment 213 and screw into the through hole 333 of the holed shaft 331. The vertical compartment 213 has an open top end to which a closure member 215 is mounted in such a way that the stop rim 42 abuts the closure member 215 while the pressing section 43 extends through the closure member 215 to project outside for being pressed down by a hand. In this way, the actuation member 40 is arranged in a vertical upright manner in the fixing base 20. Further, the extension of the pressing section 43 through the closure member 215 is in the form of multi-lateral engagement so that the actuation member 40 is allowed to take reciprocal vertical movement but is not allowed to rotate, whereby the transmission member 33 can be driven thereby to take a rotating motion.

In a different embodiment, if it is not necessary for the actuation member 40 and the rotor 31 to have a high rotational speed ratio or if it is desired to simplify the structure for reducing cost, the toothed wheel unit 32 can be omitted and the actuation member 40 can be set to directly mate and drive the pinion 312 via the coupling gear 332 of the transmission member 33.

The elastic body 50 is received in the upper portion of the vertical compartment 213. The elastic body 50 is a compression spring in the instant embodiment. The elastic body 50 has a lower end positioned on the partition 214 and an upper end positioned on the stop rim 42. The elastic body 50 provides a spring force when the actuation member 40 is pressed and moved downward, in order to help return the actuation member 40.

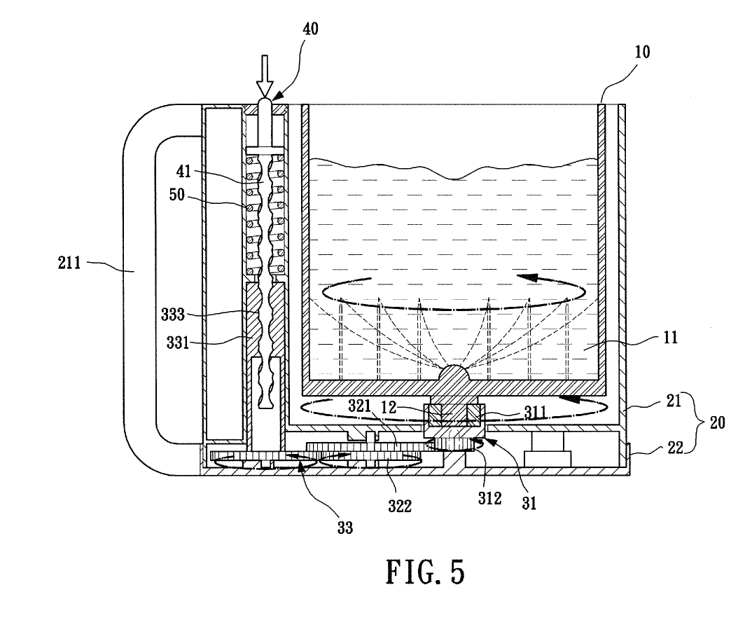

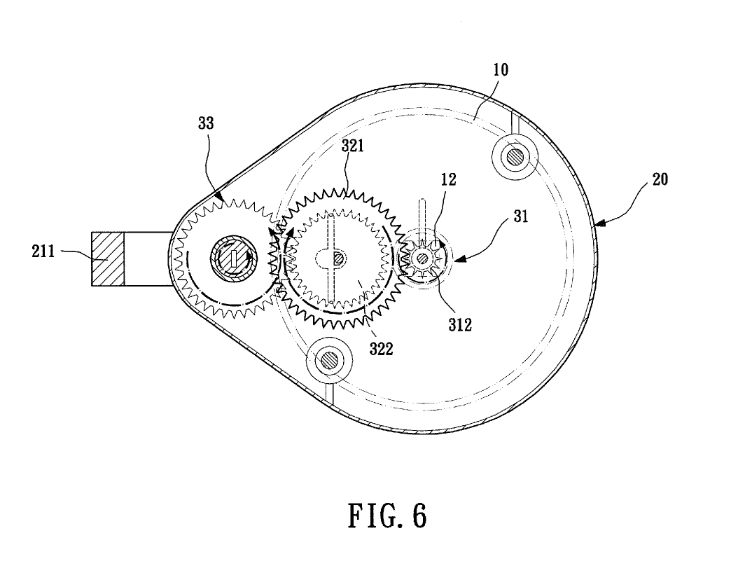

Referring to FIGS. 5 and 6, to operate the present invention, a substance to be stirred, such as a liquid, is first deposited in the container 10. Besides providing the hand-holding section 211 for holding by a hand, the present invention also allows a finger to readily press down the actuation member 40. Since the actuation member 40 is not rotatable and has a helical or screw configuration, when the actuation member 40 continuously moves downward to cause a screwing operation between the operation section 41 and the through hole 333 of the transmission member 33, the transmission member 33 is caused to rotate with respect to the actuation member 40 and the transmission member 33 drives the coupling gear 322 to rotate, so that the toothed disk 321 and the pinion 312 are sequentially caused to rotate and finally, the rotor 31 rotates to drive the axle 12, together with the container 10, to rotate. With the blending member 11 arranged inside the container 10, an effect of stirring and temperature reducing can be caused on the substance (such as liquid) inside the container 10.

Further, during the process when the actuation member 40 is moved upward by the spring force to return back to the original condition after the actuation member 40 is pressed down to cause the container 10 to rotate, due to the unidirectional rotation driving member 311 arranged between the rotor 31 and the axle 12, transmission is no longer maintained between the rotor 31 and the axle 12 and no resistance would be induced. The user can easily and successively press down the actuation member 40 to cause successive reciprocal motion thereof; keeping the container 10 continuously rotating thereby achieving a convenient and effective control of the stirring speed of the container 10.

Further, during the process when the actuation member 40 is moved upward to return back to the original condition, the axle 12 is not driven to rotate in the opposite direction so that the container 10 can keep rotating in the same direction.

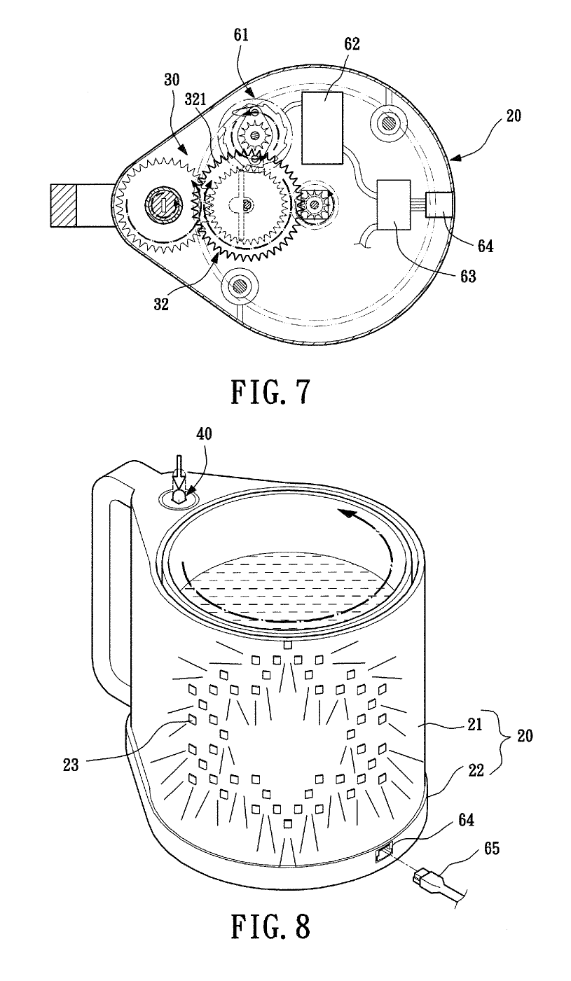

Referring to FIGS. 7 and 8, the casing 21 of the fixing base 20 has a surface on which a plurality of light-emitting elements 23, such as light-emitting diodes, is provided for emission of light and a power generation assembly 61, an electrical accumulator 62, a control circuit 63, a socket assembly 64 are included and in electrical connection therewith. The power generation assembly 61 can be a power generation device that, when driven, rotates to generate electrical power. The principle and structure of power generation applied to the power generation assembly 61 are well known and detailed description thereof will be omitted therein. The power generation assembly 61 is driving coupling with the toothed disk 321. The electrical accumulator 62 stores the electrical power generated by the power generation assembly 61. The control circuit 63 is electrically connected to the light-emitting elements 23.

As such, when a user presses down the actuation member 40 to cause the toothed disk 321 of the toothed wheel unit 32 to rotate, the power generation assembly 61 is simultaneously driven to operate so that the power generation assembly 61 generates electrical power that is supplied directly to the light-emitting elements 32 to allow the light-emitting elements 32 to give off light. As such, advantages of enhancing interest of use and utilization can be achieved. The electrical power generated by the power generation assembly 61 can be stored in the electrical accumulator 62.

The light-emitting elements 23 are controlled by the control circuit 63 to effect various lighting modes, such as continuous illumination, flashing, continuous illumination in part, flashing in part, alternating of different lighting modes, or random lighting.

The socket assembly 64 may receive a plug of an electronic device 65 (such as a mobile phone, a tablet computer, a portable power supply, and the likes) to plug therein so that the electrical power stored in the electric accumulator 62 can be supplied to the electronic device 65.

With such an arrangement, the present invention may serve as a temporary power supply, whereby an electronic device 65 owned by the user, when running out of power, can be charged by using the present invention so as to enhance the convenience and practicability of use.

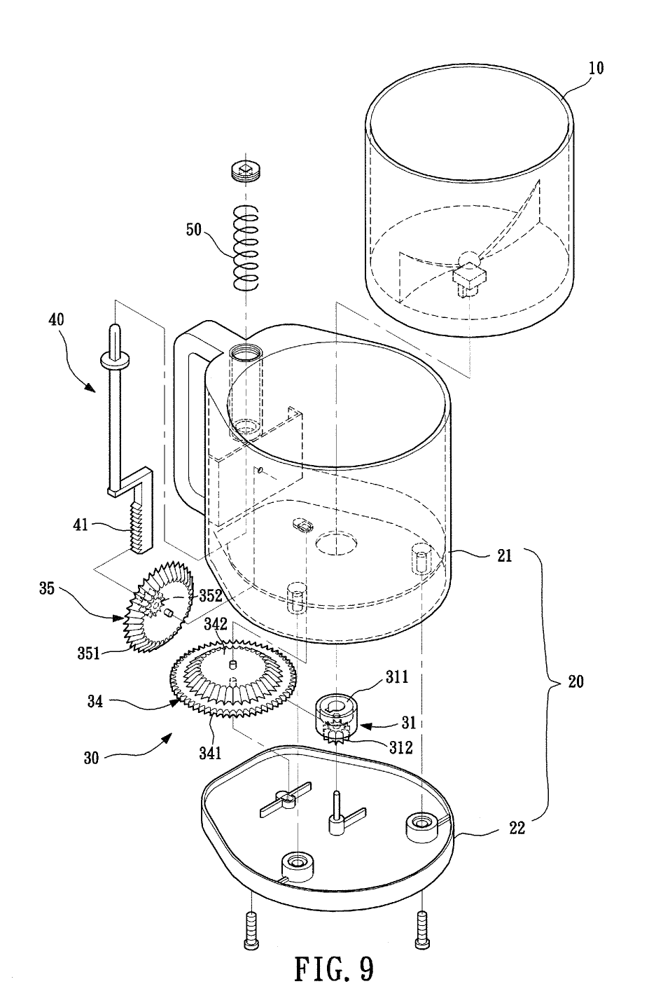

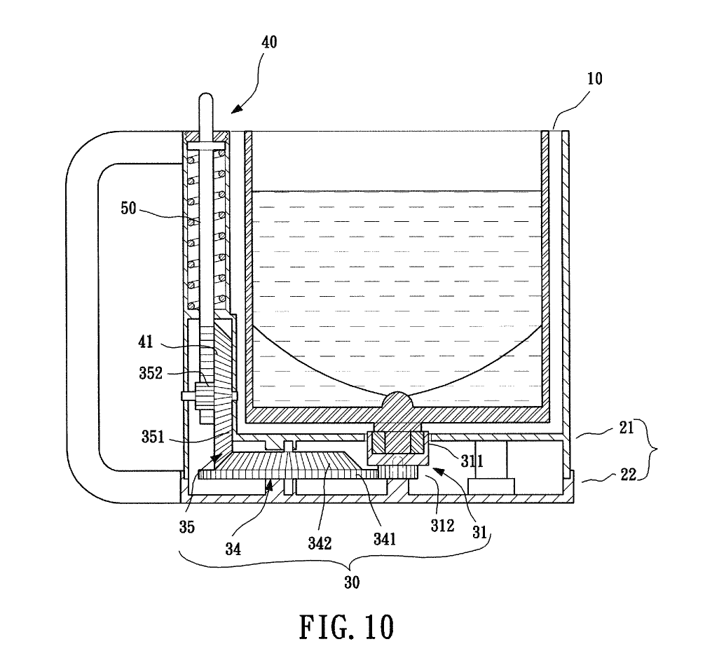

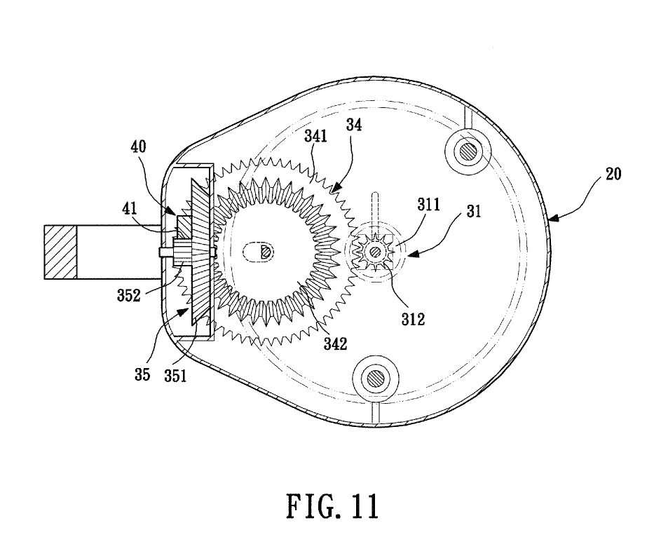

Referring to FIGS. 9, 10, and 11, another preferred embodiment of the present invention is constructed such that the rotating device 30 comprises a rotor 31 rotatably mounted to the fixing base 20, a toothed wheel assembly 34, a transmission member 35. The rotor 31 is of the same structure as that described above. The toothed wheel assembly 34 comprises a toothed disk 341 at a lower side thereof and a bevel gear 342 at an upper side thereof. The toothed disk 341 is engageable with and drives the pinion 312. The transmission member 35 comprises a bevel gear 351 and a gear 352 arranged at one side of the bevel gear 351. The actuation member 40 has an operation section 41 that comprises a toothed rack so that the operation section 41 mates and drives the gear 352.

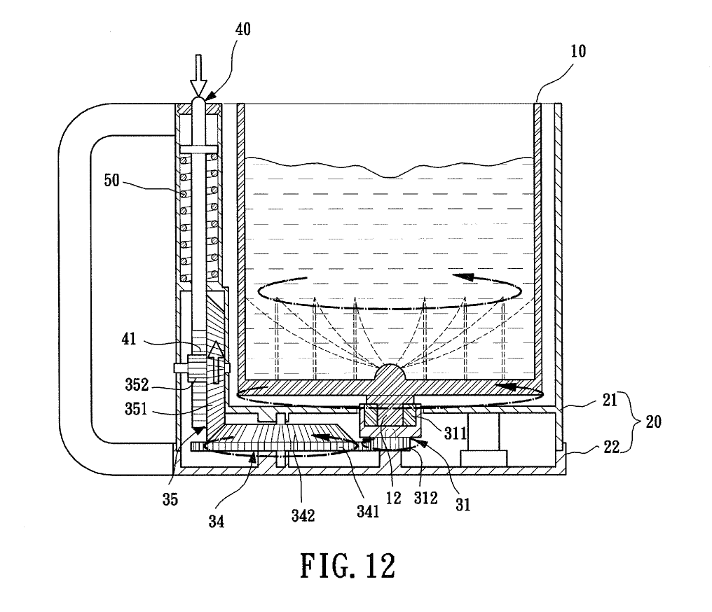

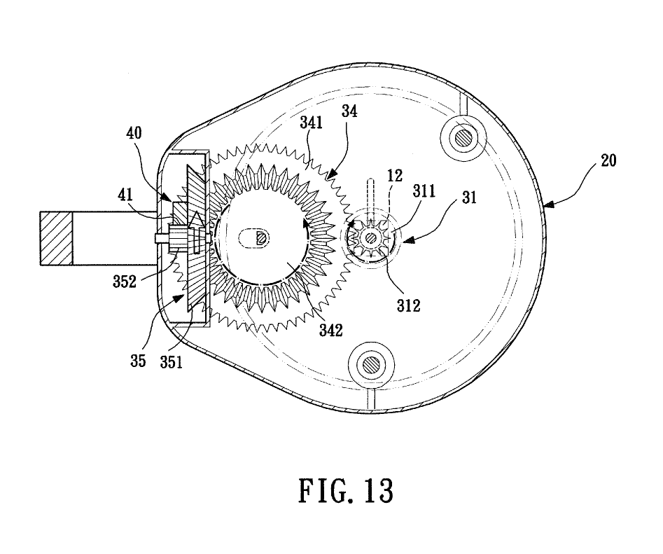

Referring to FIGS. 12 and 13, to operate said another embodiment of the present invention, the actuation member 40 is pressed down to have the operation section 41 moving downward to cause the gear 352 to rotate and then the bevel gear 351, the bevel gear 342, the toothed disk 341, and the pinion 312 are caused to rotate and eventually the rotor 31 is rotated to drive the axle 12 and the container 10 to rotate simultaneously so as to cause an effect of stirring and temperature reducing on the substance (such as liquid) received in the container 10.

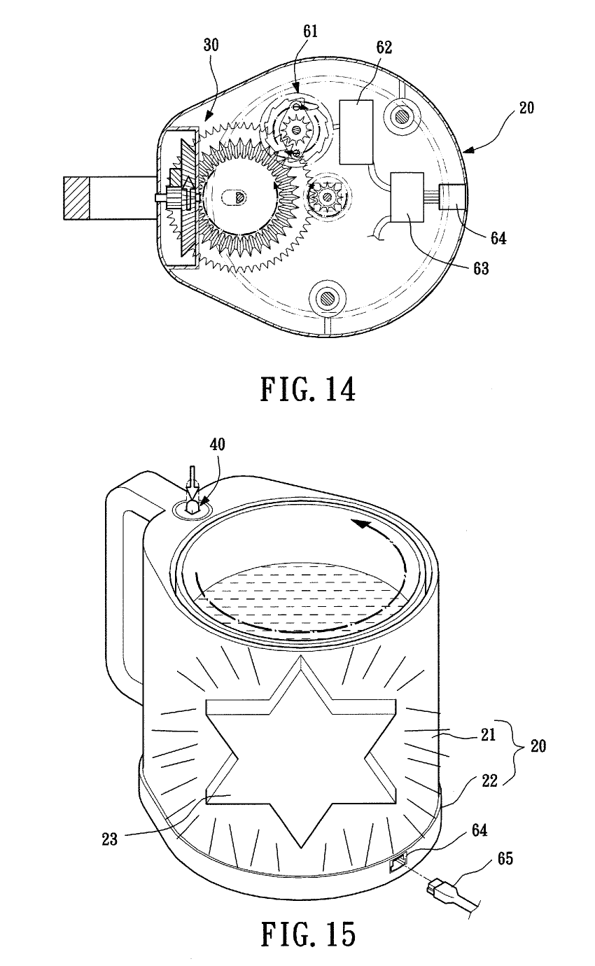

Referring to FIGS. 14 and 15, said another preferred embodiment of the present invention may also comprises light-emitting elements 23 (which can be a luminescent panel or a liquid crystal display, such as an LCD) arranged on a surface of the fixing base 20 and also comprises a power generation assembly 61, an electrical accumulator 62, a control circuit 63, a socket assembly 64.

As such, when a user presses down the actuation member 40, the light-emitting elements 23 are energized to give off light and a plug of an electronic device 65 may be received to plug therein for supply of electricity to the electronic device 65.

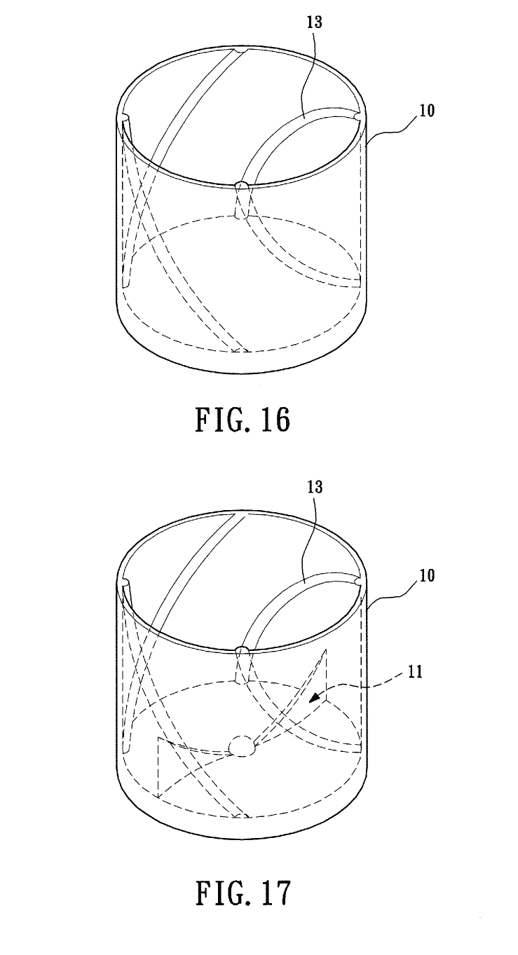

Referring to FIG. 16, the present invention also comprises a plurality of curved rib like blending members 13 circumferentially distributed on an inside surface of the container 10. The blending members 13 provide a helical stirring effect to thereby enhance the effects of stirring and temperature reducing.

Referring to FIG. 17, the container 10 may be provided, on the interior thereof, with both projecting blade like blending members 11 and the curved rib like blending members 13 in order to enhance the effects of stirring and temperature reducing.

Referring to FIG. 8, the casing 21 according to the present invention may be provided with a layer of transparent material, such as acrylic (not shown), on an outer surface thereof. The transparent material layer may comprise a plurality of recesses forming patterns or texts, whereby when the light-emitting elements 23 give off light, the light transmitting through the transparent material layer is subjected to guiding and condensation by the recesses to achieve an effect of luminous patterns or luminous texts.

Further, a light condensation and/or absorbing material, such as a fluorescent material or ink dot matrix, can be formed on the transparent material layer to show patterns or texts, so that when the light-emitting elements 23 give off light, an effect of luminous patterns or luminous texts can also be achieved.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A press-to-operate stirring container, comprising:
a container, which is adapted to receive and hold therein a substance to be stirred;
a fixing base, which carries and supports the container;
a rotating device, which comprises a rotor rotatably arranged in the fixing base, wherein the rotor comprises a unidirectional rotation driving member and a pinion, the unidirectional rotation driving member being coupled to a bottom of the container to allow the rotor to drive the container to rotate unidirectionally;
an actuation member, which is arranged vertical in the fixing base and having an upper end that is adapted to be pressed down for vertical reciprocal movement, the actuation member comprising an operation section, which drives the pinion to rotate; and
an elastic body, which is arranged in the fixing base for position returning of the actuation member in the reciprocal movement.

2. The press-to-operate stirring container according to claim 1, wherein the bottom of the container comprises an axle is mounted thereto, the axle being coupled to the unidirectional rotation driving member.

3. The press-to-operate stirring container according to claim 1, wherein the fixing base comprises a casing and a bottom board so as to form a receiving space in the fixing base for receiving therein the rotating device.

4. The press-to-operate stirring container according to claim 1, wherein the fixing base comprises a hand-holding section adapted to be held by a hand.

5. The press-to-operate stirring container according to claim 1, wherein the unidirectional rotation driving member comprises a one-way bearing.

6. The press-to-operate stirring container according to claim 1, wherein the rotating device comprises a toothed wheel unit rotatably mounted to the fixing base and a transmission member, the toothed wheel unit comprising a toothed disk at an upper side and a transmission gear at a bottom side, the toothed disk mating and driving the pinion, the rack mating and driving the transmission gear, the transmission member comprising a vertical holed shaft and a coupling gear at a lower end of the holed shaft, the holed shaft comprising a helical through hole, the coupling gear being in engagement with and driving the transmission gear, the operation section of the actuation member being of a helical form to be screwed into the through hole of the holed shaft.

7. The press-to-operate stirring container according to claim 1, wherein the fixing base comprises a vertical compartment formed in one side thereof for receiving therein the actuation member, a partition being provided in the vertical compartment to divide the vertical compartment into an upper portion and a lower portion, the actuator having an upper end on which a stop rim and a pressing section are formed, the operation section being set to partly extend through the partition with the stop rim abutting a top end of the vertical compartment and the pressing section extending through the top end of the vertical compartment to project outside for being pressed down, the extension of the pressing section through the top end of the vertical compartment being in the form of multi-lateral engagement, the elastic body being received in the upper portion of the vertical compartment, the elastic body having a lower end positioned on the partition and an upper end positioned on the stop rim.

8. The press-to-operate stirring container according to claim 1, wherein the fixing base has a surface on which a plurality of light-emitting elements is mounted and further comprising a power generation assembly and a control circuit that are in electrical connection therewith, the power generation assembly being in driving coupling with the rotating device, the control circuit being electrically connected to the light-emitting elements.

9. The press-to-operate stirring container according to claim 8, wherein the power generation assembly is electrically connected to an electric accumulator and the electric accumulator stores electrical power generated by the power generation assembly.

10. The press-to-operate stirring container according to claim 9, wherein the power supply device comprising a socket assembly, the socket assembly being adapted to receive a plug of an electronic device to be plugged therein.

11. The press-to-operate stirring container according to claim 1, wherein the rotating device comprises a toothed wheel assembly and a transmission member, the toothed wheel assembly comprising a toothed disk at a lower side thereof and a bevel gear at an upper side thereof, the toothed disk being engageable with and driving the pinion, the transmission member comprising a bevel gear and a gear arranged at one side of the bevel gear, the operation section of the actuation member comprising a toothed rack to mate and drive the gear.

12. The press-to-operate stirring container according to claim 1, wherein the container comprises therein at least one blending member for stirring the substance.

13. The press-to-operate stirring container according to claim 12, wherein the blending member comprises a projecting blade to provide a stirring effect.

14. The press-to-operate stirring container according to claim 12, wherein the blending member comprises curved ribs and a number of such curved ribs are provided on an inner circumference of the container to allow the blending member to provide an helical stirring effect.
